(19) United States
(12) Patent Application Publication
(10) Pub. No.: US 2009/0223000 A1
(43) Pub. Date: Sep. 10, 2009

(54) Manufacturing process of vegetable colorant extracts from residues generated in the extraction and processing of wood from tropical forest of colorful heartwood

(76) Inventor: Eber Lopes Ferreira, Sao Paulo (BR)

Correspondence Address: CLARK & BRODY, 1090 VERMONT AVENUE, NW, SUITE 250, WASHINGTON, DC, 20005, US

(21) Appl. No.: 12/073,470

(22) Filed: Mar. 5, 2008

(51) Int. Cl. C09B 61/00

(52) U.S. Cl. 8/439

(57) ABSTRACT

“MANUFACTURING PROCESS OF VEGETABLE COLORANT EXTRACTS FROM RESIDUES GENERATED IN THE EXTRACTION AND PROCESSING OF WOOD FROM TROPICAL FOREST SPECIES OF COLORFUL HEARTWOOD”, includes water-soluble vegetable colorant extracts, obtained from residues such as: sawdust, smoothing plane, wood parings and sawing, generated by extraction, processing and manufacturing of wood and/or triturated barks of wood from tropical forest of colorful heartwood, objecting to act on dyeing and coloration of textile fibers, paper, leather, woods and cosmetics, as much as manufacturing of different dyes to several uses.

It includes the following steps:
a) Manufacturing of water-soluble vegetable colorant extracts from residues of extraction and processing of wood of colorful heartwood of forest species. The extraction is done through aqueous lixiviation, boiling or steam entrainment by circulation of shower or steam.
b) Homogenization and condensation of the obtained extracts to increase its atomization.
c) Powder atomization of the concentrated liquid extract in a Spray-dried equipment or any other similar equipment.

Products: Natural colorants extract from residues of wood of forest species

1—Yellow Nat-TU Taiuva—specimen of the Moraceae—(Maclura tinctorial, Moráceas) natural colorant, color: ochre yellow.

2—Yellow Nat-PO Gold wood (Euxylophora paraensis, Moráceas) natural colorant, color: yellow.

3—Orange Nat-RA—Pau Rainha (Centrolobium paraense, Fabáceas) natural colorant, color: orange

4—Red Nat-CD—Sweet cedar (Bombacopsis quinata, Bombáceas) natural colorant, color: reddish

5—Red Nat-MP—Santinwood (Brosimum paraense, Fabáceas) natural colorant, color: red

613 Purple Nat-PC—Campeachy (Hematoxylon campechianum, Fabáceas) natural colorant, color: purple

7—Green Nat-VO—Violet (Peltogyne spp, Cesalpináceas) natural colorant, color: dark green

Regarding the current patent of invention “MANUFACTURING PROCESS OF VEGETABLE COLORANT EXTRACTS FROM RESIDUES GENERATED IN THE EXTRACTION AND PROCESSING OF WOOD FROM TROPICAL FOREST OF COLORFUL HEARTWONOOD”, to a manufacturing process of water-soluble colorant vegetable extract from residues such as: Saw dust, smoothing plane, wood parings and sawing, generated by extraction, processing and manufacturing of wood and/or triturated barks of wood from tropical forest of colorful heartwood, objecting to act on dyeing and coloration of textile fibers, paper, leather, woods and cosmetics, as much as manufacturing of different dyes for several uses.

Short description of the state of the art:

In seeking to reproduce the colors of the world, the human being has found in nature, among minerals, flora and fauna, the needed chromatic elements to ornament his body, utensils, adornments, weapons and houses. He transformed, so, elements from nature, in culture artifacts, imbuing these objects with the essence of his soul expressed by colors.

Vegetable colorants are living organic substances, synthesized by plants through the root absorption of different nutrients and metals derived from various kind of soil. Metabolized by moon, sunlight and photosynthesis influence it varies during the day, according to the variation of light and air as well as during the year, according to the seasons. On his endless mutation process, its colors breathe and suffer soft changes on its tonality.

The upper plants absorb existing metals on the soil (copper, aluminium, magnesium, potassium, cobalt, tin, chromium, iron and others) that catalyze biochemical synthesis reactions, making possible the formation of colorant substances on different parts of the plants (seeds, fruits, flowers, leaves, roots, barks and branches). This color fixation process on the cellular structure of the plant is known by metallization (maturation), and, in the most cases, the stability of the colors only remains while the plant will be alive.

Natural Colorant, Composition and Properties:

The natural colorant is mainly found on vegetables (upper plants, seaweeds, fungus and lichens). On upper plants, the colorants can be found on heartwoods, saps, barks, roots, leaves, flowers, fruits and seeds. It also can be found among some animals (insects and mollusks). There are insects, among them the cochineal, kermes and mollusks like squib and murex that pursues chromatic material with high power of fixation concentrated on its secretions.

These organic substances present in the metabolism of the plants and animals are classified from chromogenical groups that, by spectrophotometry, indicate a chromatic lecture standard featured of its chemical composition. They are mostly denominated by chemical organic as glycosides—compounds widely distributed in plants and by hydrolyze, release one or more sugar molecules.

Among all groups we can quote:

The natural colorants that present coloration of red spectrum (from pink to reddish-brown) are constituted by anthraquinone and/or dihydropyrenoid. Among the plants that have reddish colorants, we can quote the rubia (Rubia tictoria) which has as its colorant substance the alizarin and the Brazil wood (Caesealpinia equinata) with colorant substance the brasilina (coloring substance extracted from Brazil wood). In the midst of animal colorants, the cochineal (Coccus cacti) has as its colorant substance the carminic acid.

Amid the colorants of the spectrum orange and brown, constituted by carotenoid and/or the naphthoquinone, we can quote the annatto (Bixa orellana) that has as its colorant substance the norbixin, the reseda (Lawsonia inermis) that has as its colorant substance the henna, the walnut (Juglans regia) that has as its colorant substance the juglone tannin, and the acacia mimosa (Acacia meamsii) that has as its colorant substance the fisetin tannin.

On the spectrum of the yellows, we can find colorants constituted by flavonoids among the plants of saffron-of-land (curcuma longa), with colorant substance the turmeric, the carnation (Tagetes sp) with colorant substance the luteoline. We also find some carotenoid on plants, like the true saffron (Crocus sativus) with colorant substance the crocetine and the taiuva—specimen of the Moraceae (Maclura tinctoria), with colorant substance the morim or the maclurine.

On the spectrum of green color, the colorants are represented by chlorophylls presented on plants like garden parsley (Pretoselinum sativum) the spinach (Spinacea oleracea), the alfalfa (Medicago sativa), the urtica (Urtica dioica) and the mint (Menta piperita).

On the spectrum of the blue color, we can find the indigoids, present on the plants of anil (Indigofera tinctoria), indigo (Solanum indigoferum) and the anil (Isatis tinctoria), that has the indigotin as colorant substance.

On the spectrum of purple, the colorants are constituted by dihydropyrenoids, present on plants as campeachy wood (Haematoxylum campeachianum), that has as colorant substance the hematoxylin, and the genipap (Genipa Americana), as colorant substance the genipapine (haematein).

The natural colorants can be separately or combined used. A special feature of these colorants is the alteration of its coloration according to environmental pH or solution where it is diluted: many of them are used as indicators to measure the acidity and alkalinity of chemical solutions. Due to this feature, the natural colorants present vast versatility in its use and applications. The production of natural colorants in Brazil:

Due to a big biodiversity of Brazilian flora we can found an expressive variety of native and introduced plants, rich on natural colorants. Many of them are cultivated and used on reforestation, which makes possible its exploration and the utilization for this purpose.

As is also known, Brazil is very rich on forest species of colorful heartwood that can be found in the whole Amazonian region and West-Center. A good part of wooden stocks of the country has been already devastated, without generating any knowledge of the potential of utilization of the resulting residues from this unruly extractivism.

There is an unexplored and expressive potential for extraction and production of natural colorants obtained from residues of tropical wood in the country that is still unknown and deserves bigger attention.

According IBAMA (Environmental Brazilian Institute), in 1997, was authorized cutting of 25 million of cubic meters of wood in Brazil. Among it, we can surpass liable forest species for colorants extraction such as campeachy wood (Hematoxylon campechianum, Fabáceas), yellow ibiurana, mirixi, jabotá, little lemon, ipê-amarelo (common name of several Brazilian trees and shrubs (Caesalpinia, Bignonia and Boraginaceae) of the genus Tabebuia (with violet and yellow flowers), bitter cedar, sweet cedar (Bombacopsis quinata, Bomáceas), little purple (Peltogyne spp., Cesalpináceas), pau rainha (Centrolobium paraense, Fabáceas), black sucupira (Diplotropis purpurea, Fabáceas, taiuva—specimen of the Moraceae (Maclura tinctoria, Moráceas) and satinwood (Brosimum paraense, Fabáceas), among several others. On the processing of these woods, only 30% of the total is utilized for the wood companies, which makes us deduce that 70% of the total extracted wood for commercial purposes in the country is despised.

Considering an average using of 4% of vegetable colorant extract extracted from gross weight, we are talking of hundreds of tons of potential daily production of vegetable colorant extracts.

In the whole Amazon, on extraction places of logs of wood, stays a big quantity not utilized of residues such as branches, stem basis of a tree and roots. Moreover, on sawmills, the logs suffers the lopping, and the barks and the external layer of the stem are despised, as well as those parts with deformations and fissures. During processing, when the logs are transformed on boards, resulting in a huge quantity of sawmill residues that, in some cases, it is used as fuel on drying process of wood. But, the quantity of residues generated is much more than the quantity utilized on drying process and a big surplus quantity is burned or despised, to open sky, without any utilization. On all these steps, since the wood processing, the generated residues can be used for production of colorant extracts, with several applications on food industry, cosmetics, paper and textile.

Adding to this, the deep knowledge of traditional Brazilian people about the production and using of natural colorant from native plants passed from father to son through generations. Many of these plants can be cultivated , such as annatto (Bixa ollerana, Bixáceas), the saffron of the land (Curcuma longa, Zingibereáceas), the indigo plant (Indigofera tinctoria, Fabáceas), the spinach (Spinacea oleracea), the genipap, the assai palm (Euterpe oleracea) and many other that, associated to a industrial process of extraction, can become a income source for small rural producers.

The production of natural colorants from cultivable plants and the residues utilization is justified, mainly, by economical potential. The large quantity of colorant raw material existing in Brazil, when properly utilized, can contribute significantly to reversing the position of Brazilian trade balance, on this economic segment, and, so, becoming the country in a great exporter of vegetable extracts and colorant raw material from vegetable origin.

### Summary of Patent:

The description consists on a manufacturing process of vegetable colorants from residues, residues and rests of extraction, processing and industrialization of tropical wood species that supplies colorful heartwood woods: heartwood residues such as: Saw dust, smoothing plane, wood parings and sawing and/or barks of tropical trees. Thus, the obtained extracts can be used on several applications to give coloration and on dyeing of different textile products, paper, wood, leather and manufacturing of dyes in general.

The extracts of the natural colorants are obtained by aqueous lixiviation of the leaves, roots, branches, barks, flowers, fruits, seeds and residues of forest native species, cultivated and/or reforested. It also can be extracted from lichens, fungus and seaweeds as much as some animals, like cochineals and squids. The extraction is done in stainless equipment, or copper or tempered glass, or even aluminium, with a temperature of 60° to 120° C. (Celsius degrees). The extraction occurs in a closed system type self heating to steam and pressure, or open to ebullition, and also in an extractor type Soxhlet with coupling condenser, or any other industrial equipment able to realize the extraction. On this equipment, the entrainment is done through the circulation of the shower or the steam, extracting the colorant and making it water solvable.

It has the objective to act on coloration and dyeing processes of textile fibers, leather, paper, wood and cosmetics, as also on fabrication of dye to different purposes, such as water-soluble and/or hydro missive extracts, without using chemical solvable, due to the interest of the companies in adjustment to environmental standards, which takes them to look for sources of color that causes less environmental impact and are able to substitute the chemical aniline that attacks the environment and affects the health of its employees and consumers.

Thus, the technique consists on the following steps:

a) These extracts are obtained by the aqueous lixiviation, boiling or entrainment with liquid steam from leaves, roots, barks, branches, flowers, fruits, seeds and residues of forest native species, cultivated and/or reforested when triturating the parts of the plant to be used for extraction increasing the contact are resulting in a more efficient extraction. In stainless or inert plastic equipment, or any other equipment able to this purpose, we put the triturated raw material immersed in clean water, in ambient temperature for a period from 2 to 48 hours, where are added an alcohol or an alkali, or any other solvent that can be used for this purpose. The alcohol used can be from cereals, methanol, ethanol, isopropanol, butanol, cyclobutanol, pentanol or a mixture in any proportion of these, on concentration of 0.01 to 50 g/liter of solution. As alkali, can be used sodium hydroxide, potassium hydroxide, lithium hydroxide, calcium hydroxide, magnesium hydroxide, beryllium hydroxide, ammonium hydroxide or ammonia, sodium carbonate (Na2CO3), or potassium hydroxide (KOH) or a water of ash (lye) on concentration of 0.01 to 50 g/liter of the solution.

b) To let the mixture homogeny it has to be agitated and so is done the extraction by lixiviation or entrainment under pressure in stainless equipment, or copper or tempered glass, or aluminum, from 60° to 120° C. temperature. The extraction occurs in a self heating closed system to steam and pressure, or open to ebullition, and also in an extractor type Soxhlet with a coupling condenser, or any other industrial equipment able for this extraction. On this equipment, the entrainment is done through shower or steam circulation, extracting the colorant and making it water solvable. On this way, is obtained the liquid water-soluble natural extracts.

c) Then, is made the homogenization and the condensation by agitation in a stainless recipient, or any other material, using a condenser, or by exhalation, with the objective of reducing the quantity of water from the resulting extract increasing the concentration.

d) If necessary, it is dehydrated by powder atomization of the concentrated liquid extract in Spray-dried equipment, or any other industrial equipment able to this purpose resulting in a powder vegetable colorant.

Colorants extracted from Tropical Forest species residues.

### EXAMPLE 1

Taiuva Natural Colorant (I 5465)
Haley, B., J. Am. Pharm. Assoc. 40, 111 (1951)
Laidlow, S., Chem & ind (London) 1959, 1604

The natural extract produced from taiuva—specimen of the Moraceae—(Maclura tinctoria, Moráceas) heartwood residues is featured by an ochre yellow coloration. This forest species is found in Latin America where exists in large scale in Atlantic Forest and Amazon region. Its principal active component is morintanico (acid extracted from mulberry tree) from flavonoid chromogenical group. The main coloring element is the maclurina, which is featured for presenting an ochre yellow coloration. As colorant applied on wool, silk and cotton, are obtained tonalities varying from light yellow to orange yellow. On the presence of alum, it becomes gold, on the presence of CHROMIUM, brown, on the presence of copper, orange yellow, on the presence of iron, greenish gray.

It presents a good solidity on vegetable (cotton, flax, sisal, ramie) origin fiber and animal (wool and silk).Its light, washing and sweat resistance is good, and it can be used to coloring leather during tanning process with vegetable tannin.

Extraction Process

From immersion of residues such as: Saw dust, smoothing plane, wood parings and sawing generated from processing and industrialization of wood and/or triturated barks of taiuva—specimen of the Moraceae—in water, alcohol or alkali solution or any other kid of solvable able to this purpose, in ambient temperature for a period from 2 to 48 hours, the extraction is started. The alcohol used can be from cereals, methanol, ethanol, isopropanol, butanol, cyclobutanol, pentanol or a mixture in any proportion of these, on concentration of 0.01 to 50 g/liter of solution. As alkali, can be used sodium hydroxide, potassium hydroxide, lithium hydroxide, calcium hydroxide, magnesium hydroxide, beryllium hydroxide, ammonium hydroxide or ammonia, sodium carbonate (Na2CO3), or potassium hydroxide (KOH) or a water of ash (lye) on concentration of 0.01 to 20 g/liter of the solution. The extraction is done in stainless equipment, or copper or tempered glass, or even aluminium, with a temperature of 60° to 120° C. (Celsius degrees). The extraction occurs in a closed system type self heating to steam and pressure, or open to ebullition, and also in an extractor type Soxhlet with coupling condenser, or any other industrial equipment able to realize the extraction. On this equipment, the entrainment is done through the circulation of the shower or the steam. The resulting product is a yellowish-brown coloration dense liquid rich in flavonoids.

The liquid extract is condensed by water remove of its composition, using, for doing this, a condenser, or through the evaporation by boiling the solution. Depending on its application, is done the standardization of its concentration. The resulting extract has good solubility in hot water and when used on dyeing of textile fibers presents a good penetration, good power of coloration and excellent efficiency.

Composition: Morintanico Acid and demineralized water.

Chemical Name: Maclurina or morintanico acid. Flavonoid.
Chemical Formula: C13H1006
Molecular Weight: 262.21

When isolated, the substance is presented as an orange yellow powder. Low solubility in cold water. Solvable in hot water, alcohol and alkali solutions.
Typical Analysis
Physical Aspect: yellowish brown extract
Ionic Character: Anionic
pH: 3, 5-6, 0
Color: yellow to dark yellowish brown

### EXAMPLE 2

### Satinwood Natural Colorant

The natural extract produced from satinwood (Brosimum paraense, Fabáceas) heartwood residues is featured by a brick red coloration. This forest species is found in Latin America where it exists spontaneously in large scale in Atlantic Forest and Amazon region. Its principal active component is the muirapirina featured for presenting a brick red coloration. As colorant applied on dyeing of wool, silk and textile fibers such as cotton and flax, are obtained tonalities varying from orange pink (salmon) on the presence of potassium alum, aluminium acetate, aluminium sulphate; on the presence of potassium bichromate, purple, on the presence of iron sulphate and iron acetate, violet, on the presence of tin, scarlet red.

It presents a good tinctorial affinity and good resistance on textile fibers. It also is used under the chromium as base for synthetic colorant and during darkening and tanning leather process with vegetable tannin.

### Extraction Process

From immersion of residues such as: Saw dust, smoothing plane, wood parings and sawing generated from processing and industrialization of wood and/or triturated barks of satinwood in water, alcohol or alkali solution or any other kid of solvable able to this purpose, in ambient temperature for a period from 2 to 48 hours, the extraction is started. The alcohol used can be from cereals, methanol, ethanol, isopropanol, butanol, cyclobutanol, pentanol or a mixture in any proportion of these, on concentration of 0.01 to 50 g/liter of solution. As alkali, can be used sodium hydroxide, lithium hydroxide, calcium hydroxide, magnesium hydroxide, beryllium hydroxide, ammonium hydroxide or ammonia, sodium carbonate (Na2CO3), or potassium hydroxide (KOH) or a water of ash (lye) on concentration of 0.01 to 20 g/liter of the solution. The extraction is done in stainless equipment, or copper or tempered glass, or even aluminium, with a temperature of 60° to 120° C. (Celsius degrees). The extraction occurs in a closed system type self heating to steam and pressure, or open to ebullition, and also in an extractor type Soxhlet with coupling condenser, or any other industrial equipment able to realize the extraction. On this equipment, the entrainment is done through the circulation of the shower or the steam. The resulting product is a dark reddish-brown coloration dense liquid rich in dihydropyrenoids.

The liquid extract is condensed by water remove of its composition, using, for doing this, a condenser, or through its evaporation by boiling the solution. Depending on its application, is done the standardization of its concentration. The resulting extract has good solubility in hot water and when used on dyeing of textile fibers presents a good penetration, good power of coloration and excellent efficiency.

Composition: Santinwood extract and demineralized water.

Chemical Name: Muirapirina dihydropyrenoids.
Chemical Formula: C16H1405
Molecular Weight: 286.27

When isolated, the substance is presented as orange crystals. Solvable in water and alcohol. Under alkaline solutions it presents a carmine red coloration.
Typical Analysis
Physical Aspect: reddish-brown extract
Ionic Character: Anionic
pH: 3, 5-6, 0
Color: from terracotta salmon to dark brick

### EXAMPLE 3

Campeachy woods natural extract (14496)
Chevreul, Ann. Chim. Phyus. 82, 54, 126 (1810)
Morsing, R., Tetrahedron 26, 281 (1970)

The natural extract produced from Campeachy wood is a liquid of purple red coloration produced from residues of campeachy wood heartwood. This forest species is found in Latin America where is reforested in large scale. Its principal active component is hematoxyllin, features by a purple coloration, from dihydropyrenoid chromogenical group. As colorant applied on wool, silk and cotton, are obtained tonalities varying from lilac to black. On the presence of potassium alum, aluminium potassium and aluminium acetate, it becomes bluish violet, on the presence of potassium bichromate, dark blue, on the presence of copper sulphate, copper acetate, grayish blue, on the presence of iron acetate, iron sulphate, ferrous sulphate and rust, it becomes from navy blue to black; on the presence of tin chloride, it becomes bordeaux. The tinctorial affinity of this colorant is defined through dyeing process and by the applied mordant, presenting good solidity on vegetable (cotton, flax, sisal and ramie) and animal (wool and silk) origin fibers. Its resistance to alkali, friction and sweat is good. In applications from 3% to 6% of iron or copper mordant its resistance to light is excellent and resistance to alkali and washing is very good.

### Extraction Process

From immersion of residues such as: Saw dust, smoothing plane, wood parings and sawing generated from processing and industrialization of wood and/or triturated barks of campeachy wood in water, alcohol or alkali solution or any other kid of solvable able to this purpose, in ambient temperature for a period from 2 to 48 hours, the extraction is started. The alcohol used can be from cereals, methanol, ethanol, isopropanol, butanol, cyclobutanol, pentanol or a mixture in any proportion of these, on concentration of 0.01 to 50 g/liter of solution. As alkali, can be used sodium hydroxide, lithium hydroxide, calcium hydroxide, magnesium hydroxide, beryllium hydroxide, ammonium hydroxide or ammonia, sodium carbonate (Na2CO3), or potassium hydroxide (KOH) or a water of ash (lye) on concentration of 0.01 to 20 g/liter of the solution. The extraction is done in stainless equipment, or copper or tempered glass, or even aluminium, with a temperature of 60° to 120° C. (Celsius degrees). The extraction occurs in a closed system type self heating to steam and pressure, or open to ebullition, and also in an extractor type Soxhlet with coupling condenser, or any other industrial equipment able to realize the extraction. On this equipment, the entrainment is done through the circulation of the shower or the steam. The resulting product is a dark purple coloration dense liquid rich in dihydropyrenoid.

The liquid extract is condensed by water remove of its composition, using, for doing this, a condenser, or through the evaporation by boiling the solution. Depending on its application, is done the standardization of its concentration. The resulting extract has good solubility in hot water and when used on dyeing of textile fibers presents a good penetration, good power of coloration and excellent efficiency.

Composition: Hematoxyllin and demineralized water.
Chemical Name: Hematoxyllin
Chemical Formula: C16H1406
Molecular Weight: 302.29

When isolated, the substance is presented as a purple red powder. Low solubility in cold water. Solvable in hot water, alcohol and alkali solutions.
Typical Analysis
Physical Aspect: purple extract
Ionic Character: Anionic
pH: 4, 5-9, 0
Color: purple, blue, from violet to black

### EXAMPLE 4

### Sweet Cedar Natural Colorant

The natural extract produced from residues such as: Saw dust, smoothing plane, wood parings and sawing, generated by extraction, processing and manufacturing of wood and/or triturated barks of sweet cedar (Bombacopsis quinata, Bombáceas) is features by a reddish coloration.

### EXAMPLE 5

Tatajuba Natural colorant

The natural extract produced from residues such as: Saw dust, smoothing plane, wood parings and sawing, generated by extraction, processing and manufacturing of wood and/or triturated barks of tatajuba—fustic (Bagassa guianensis, Moráceas) is featured by a yellowish brown coloration.

### EXAMPLE 6

### Black Sucupira Natural Colorant

The natural extract produced from residues such as: Saw dust, smoothing plane, wood parings and sawing, generated by extraction, processing and manufacturing of wood and/or triturated barks of black sucupira (Diplotropis purpurea, Fabáceas) is featured by having a coloration dark brown near black.

### EXAMPLE 7

### Pau Rainha Wood Natural Colorant

The natural extract produced from residues such as: Saw dust, smoothing plane, wood parings and sawing, generated by extraction, processing and manufacturing of wood and/or triturated barks of Pau Rainha wood (Centrolobium paraense, Fabáceas) is featured by an orange coloration.

### EXAMPLE 8

### Violet Natural Colorant

The natural extract produced from residues such as: Saw dust, smoothing plane, wood parings and sawing, generated by extraction, processing and manufacturing of wood and/or triturated barks of violet (Peltogyne spp, Cesalpináceas) is featured by a moss green coloration.

1. “MANUFACTURING PROCESS OF VEGETABLE COLORANT EXTRACTS FROM RESIDUES GENERATED IN THE EXTRACTION AND PROCESSING OF WOOD FROM TROPICAL FOREST SPECIES OF COLORFUL HEARTWOOD”, featured by manufacturing process of water-soluble colorant vegetable extract from residues such as: Saw dust, smoothing plane, wood parings and sawing, generated by extraction, processing and manufacturing of wood and/or triturated barks of wood from tropical forest species of colorful heartwood. It includes several steps, as follows: a) The obtainment of vegetable colorant extracts from leaves, roots, barks, branches, flowers, fruits, seeds and residues of native forest species, cultivated and/or reforested which contains in its composition colorant substances. The raw material is triturated, immersed in clean water under ambient temperature in a period from two to 48 hours, added of alcohol (from cereals, methanol, ethanol, isopropanol, butanol, cyclobutanol, pentanol, or a mixture in any proportion of these) on concentration from 0.01 to 50 g/liter of the solution and/or a alkali (sodium hydroxide, potassium hydroxide, lithium hydroxide, calcium hydroxide, magnesium hydroxide, beryllium hydroxide, ammonium hydroxide or ammonia, sodium carbonate (Na2CO3) or potassium hydroxide (KOH) or any other soft alkali as water of ash (lye) or any other kind of solvable, proper for this purpose, on concentration of 0.01 to 20 g/liter of the solution; b) Objecting the homogenization the agitation is provoked and the extraction is done by aqueous lixiviation, boiling or steam entrainment in stainless equipment, or copper, or tempered glass, or aluminium, or any other material, under temperature from 60° to 120° C., resulting in a extraction in a closed system type self heating to steam and pressure, or open to ebullition, and also in an extractor type Soxhlet with coupling condenser, or any other industrial equipment able to realize the extraction; c) the homogenization and condensation are done in a stainless recipient, using a condenser, or by ebullition, objecting reducing the quantity of water from the resulting extract, making it more concentrated.; d) when necessary, the dehydration is done by powder atomization of the concentrated liquid extract in a Spray-dried equipment or any other similar equipment, resulting, so, in a powder vegetable colorant extract.

2. “MANUFACTURING PROCESS OF VEGETABLE COLORANT EXTRACTS FROM RESIDUES GENERATED IN THE EXTRACTION AND PROCESSING OF WOOD FROM TROPICAL FOREST SPECIES OF COLORFUL HEARTWOOD”, according to claim 1, featured by the fact that that are obtained the following products: 1) Yellow Nat-TU—Taiuva—specimen of the Moraceae—natural colorant, produced from residues of the heartwood of tauiva (Maclura tinctoria, Moráceas): 2—Yellow Nat-PO—Gold wood natural colorant, produced from residues of heartwood of gold wood (Euxylophora paraensis, Moráceas); 3) Orange Nat-RA—Pau Rainha natural colorant, produced from residues of heartwood of pau rainha (Centrolabium paraense, Fábaceas); 4) Red Nat-CD—Sweet cedar natural colorant, produced from residues of heartwood of sweet dear (Bombacopsis quinata, Bombáceas); 5) Red Nat-MP—Satinwood natural colorant, produced fro residues of heartwood of santiwood (Brosimum paraense, Fabáceas); 6) Purple Nat-PC—Campeachy wood natural colorant, produced from residues of heartwood of campeachy wood (Hematoxylon campechianum, Fabáceas); 7) Green Nat-VO—Violet natural colorant, produced from residues of heartwood of violet (Peltogyne spp, Cesalpináceas).
